(19) United States
(12) Patent Application Publication
(10) Pub. No.: US 2024/0345780 A1
(43) Pub. Date: Oct. 17, 2024

(54) INFORMATION PROCESSING APPARATUS AND METHOD OF CONTROLLING INFORMATION PROCESSING APPARATUS

(71) Applicant: CANON KABUSHIKI KAISHA, Tokyo (JP)

(72) Inventor: Hinako Ishii, Tokyo (JP)

(21) Appl. No.: 18/623,107

(22) Filed: Apr. 1, 2024

(30) Foreign Application Priority Data
Apr. 14, 2023 (JP) 2023-066520

(51) Int. Cl. G06F 3/12

(52) U.S. Cl. CPC G06F 3/1205; G06F 3/1258

(57) ABSTRACT

An information processing apparatus accepts an editing operation to change registered first paper information. Paper information based on the accepted editing operation is registered as second paper information, which is different from the first paper information, in a case where a type of the first paper information is base paper, and the registered first paper information is overwritten with the paper information based on the editing operation in a case where the type of the first paper information is not the base paper.

### BACKGROUND OF THE INVENTION

### Field of the Invention

The present disclosure relates to an information processing apparatus and a method of controlling the information processing apparatus.

### Description of the Related Art

There has been a technique of setting a type of paper fed in a feeding tray. Japanese Patent Laid-Open No. 2002-029120 discloses an image processing apparatus that has a function to register a paper type customized by a user with a database (DB) and a function to select an arbitrary paper type from the DB and set the selected paper type as the paper type of the feeding tray.

The quality of a printing image in the image processing apparatus depends on whether the characteristics of the image processing apparatus (conveyance characteristics, transfer characteristics, fixation characteristics, and so on) and the characteristics of the paper (surface property, basis weight, and so on) adapt to each other. Japanese Patent Laid-Open No. 2020-012940 discloses an image processing apparatus capable of registering a characteristic value with a paper DB in association with each paper type in advance. There has been demanded an improvement in the usability in changing paper information indicating the characteristics of paper.

### SUMMARY OF THE INVENTION

An information processing apparatus according to an aspect of the present disclosure includes: one or more memories storing instructions; and one or more processors executing the instructions to: accept an editing operation to change registered first paper information; and register paper information based on the accepted editing operation as second paper information, which is different from the first paper information, in a case where a type of the first paper information is base paper, and overwrite the registered first paper information with the paper information based on the editing operation in a case where the type of the first paper information is not the base paper.

Further features of the present invention will become apparent from the following description of exemplary embodiments with reference to the attached drawings.

### BRIEF DESCRIPTION OF THE DRAWINGS

FIG. 1 is a diagram illustrating a configuration of a printing system;

FIG. 2 is a block diagram illustrating a hardware configuration of an image processing apparatus;

FIG. 3 is a diagram illustrating an example of a software configuration of the image processing apparatus;

FIG. 4 is a diagram illustrating an example of a screen displayed on the image processing apparatus;

FIG. 5 is a diagram illustrating a screen to check and edit details of paper information;

FIG. 6 is a diagram illustrating a screen to check and edit the details of the paper information;

FIG. 7 is a diagram illustrating an example of a screen to change a name;

FIG. 8 is an example illustrating a screen including a pop-up; and

FIG. 9 is a flowchart illustrating an example of processing of editing the paper information.

### DESCRIPTION OF THE EMBODIMENTS

Preferred embodiments of the present disclosure are described below in detail with reference to the appended drawings. Note that, the following embodiments are not intended to limit the matters of the present disclosure, and not all the combinations of the characteristics described in the following embodiments are necessarily required for the means for solving the problems of the present disclosure. Note that, the same configurations are described with the same reference numerals.

### First Embodiment

In the present embodiment, a mode to improve the usability in changing paper information indicating the characteristics of paper is described. As described later, the paper information includes various characteristics. Additionally, the paper information includes a paper type as an item indicating an attribute of paper. Two paper types are used as the paper type. The first paper type is a paper type registered with an image processing apparatus in advance at the product delivery. The paper of the first paper type is referred to as base paper. The base paper includes a characteristic value determined in advance, and the change of the characteristic value of the base paper itself is not allowed. In a case where a user wants to use the base paper with a changed characteristic value, it is necessary to use the second paper type, which is a duplication of the base paper. The paper of the second paper type is referred to as user setting paper.

Thus, in a case where the user registers new paper information, a user operation to designate desired base paper, a user operation to instruct duplication of the designated base paper, a user operation to change the characteristic value of the duplicated paper (user setting paper), and the like are required. Those operations are cumbersome operations for the user and are also non-intuitive operations; for this reason, the usability is reduced.

Particularly, in a case of high quality printing, there are many cases in which various characteristic values are changed from the base paper registered at the product delivery. In addition, because of growing demand for high quality printing on special paper, the number of the users who demand to change the paper information has been increasing. Therefore, there has been demanded to improve the usability in changing the paper information.

In the embodiments described below, an example in which the user can register the new paper information without a user operation to instruct the duplication of the designated base paper is described.

### <System Configuration>

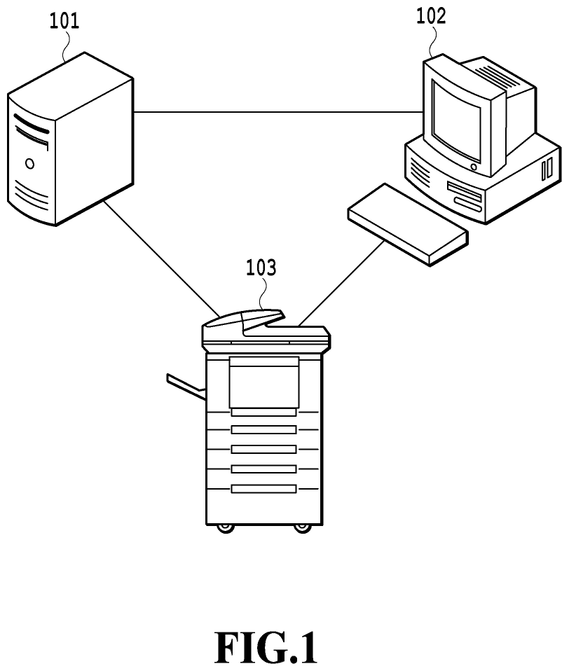

FIG. 1 is a diagram illustrating a configuration of a printing system in the present embodiment. The printing system includes a server apparatus 101, a client apparatus 102, and an image processing apparatus 103 connected on a network.

The server apparatus 101 is a type of information processing apparatus and transmits and receives various data to and from the image processing apparatus 103 and the client apparatus 102. The client apparatus 102 is also a type of information processing apparatus and transmits and receives various data to and from the image processing apparatus 103 and the server apparatus 101. The server apparatus 101 and the client apparatus 102 may be any type of information processing apparatus such as a server terminal, a personal computer, a tablet, a smartphone, or the like, for example.

The image processing apparatus 103 is a printer apparatus and is a multifunction peripheral (MFP) in the present embodiment. The image processing apparatus 103 has not only a function to copy a paper document but also a function to print printing data transmitted from an external printer driver and a function to read the paper document and transmit image data thereof to an external file server or an e-mail address (SEND function). In addition, the image processing apparatus 103 has a function to transmit data to another image processing apparatus that is not illustrated and perform printing by the image processing apparatus as a transmission destination (remote copying function or facsimile function) and the like. Additionally, the image processing apparatus 103 of the present embodiment has a function to register the paper information, and the image processing apparatus 103 is also a type of the information processing apparatus.

The image processing apparatus 103 is connected by a not-illustrated Ethernet (registered trademark); however, it is not limited to this example. The image processing apparatus 103 may be connected by an arbitrary network. Additionally, an interface may be either wired or wireless. The server apparatus 101 and the client apparatus 102, other than the image processing apparatus 103, are exemplified as individual apparatuses; however, the server apparatus 101 and the client apparatus 102 may be formed of the same computer. In addition, the image processing apparatus 103 may implement the functions of the server apparatus 101 and the client apparatus 102. A printing type of the image processing apparatus 103 in the present embodiment may be either an electrophotographic type, an ink jet type, or another type.

### <Hardware Configuration of Image Processing Apparatus>

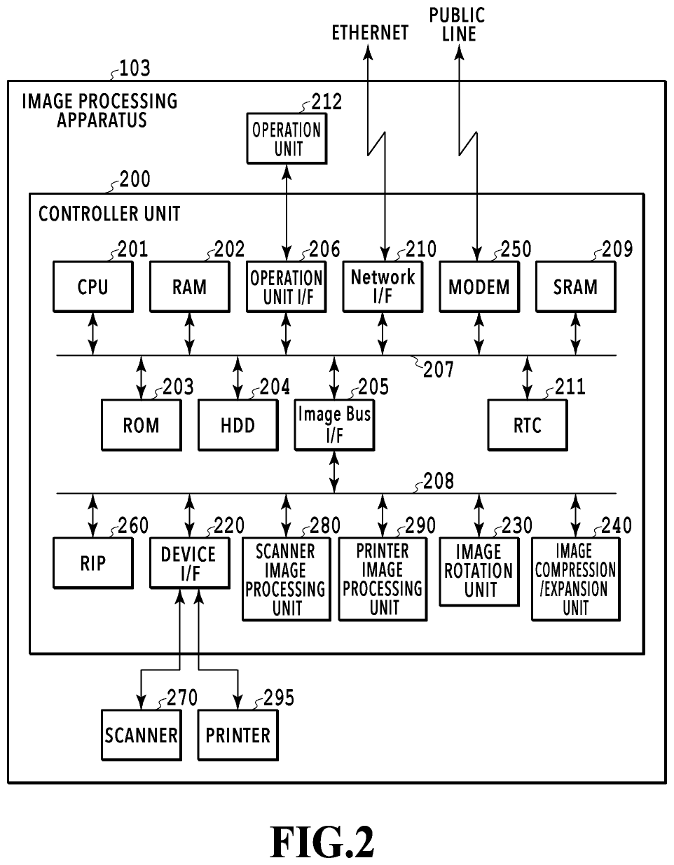

FIG. 2 is a block diagram illustrating a hardware configuration of the image processing apparatus 103 of the present embodiment. The image processing apparatus 103 includes a controller unit 200, an operation unit 212, a scanner 270, and a printer 295. The controller unit 200 includes a CPU 201, a RAM 202, a ROM 203, an HDD 204, an Image Bus I/F 205, an operation unit I/F 206, an SRAM 209, a Network I/F 210, an RTC 211, and a MODEM 250. The above devices are arranged on a system bus 207.

Additionally, the controller unit 200 includes a device I/F 220, an image rotation unit 230, an image compression/expansion unit 240, a scanner image processing unit 280, and a printer image processing unit 290. The above devices are arranged on an image bus 208.

The controller unit 200 is connected with the scanner 270 as an image input device and the printer 295 as an image output device. Additionally, the controller unit 200 inputs and outputs image information and device information through a connection with the Ethernet (registered trademark) and a public line.

The CPU 201 is a controller that controls the image processing apparatus 103. The RAM 202 is a system working memory that allows the CPU 201 to operate and is also an image memory to temporarily store the image data. The ROM 203 is a boot ROM and stores a boot program of the system. The HDD 204 is a hard disk drive and stores system software, an application, and the image data.

The operation unit I/F 206 is an interface unit for the operation unit 212 including a touch panel and outputs the image data to be displayed on the operation unit 212 to the operation unit 212. Additionally, the operation unit I/F 206 has a role in notifying the CPU 201 of information inputted by the user through the operation unit 212. The Network I/F 210 is connected to a network and inputs and outputs the information. The MODEM 250 is connected to the public line and inputs and outputs the information.

The SRAM 209 is a non-volatile storage medium capable of operating at high speed. The RTC 211 is a real-time clock and performs processing of continuous counting of the current time even in a state in which the controller unit 200 is powered off.

The Image Bus I/F 205 is a bus bridge that connects the image bus 208 and the system bus 207 with each other through which the image data is transferred at high speed and converts a data structure. The image bus 208 is formed of a PCI bus or IEEE 1394.

An RIP 260 is a raster image processor and rasterizes a PDL code into bitmap image data. The device I/F 220 connects the scanner 270 and printer 295 as the image input and output devices and the controller unit 200 with each other and performs synchronous/asynchronous conversion of the image data. The scanner image processing unit 280 corrects, processes, and edits the input image data. The printer image processing unit 290 corrects output image data to be printed and converts the resolution thereof, for example. The image rotation unit 230 rotates the image data. The image compression/expansion unit 240 performs compression and expansion processing.

The printer 295 includes one or more feeding units. The feeding units each store paper as a printing medium. The paper information on the paper stored in each feeding unit can be set to the corresponding feeding unit. Thus, high quality printing is performed by the printer 295.

The above-described configuration of the image processing apparatus 103 is merely an example, and it is not limited thereto. A part of the configuration illustrated in FIG. 2 may not be included, and a configuration that is not illustrated in FIG. 2 may be included in the image processing apparatus 103.

### <Software Configuration of Image Processing Apparatus>

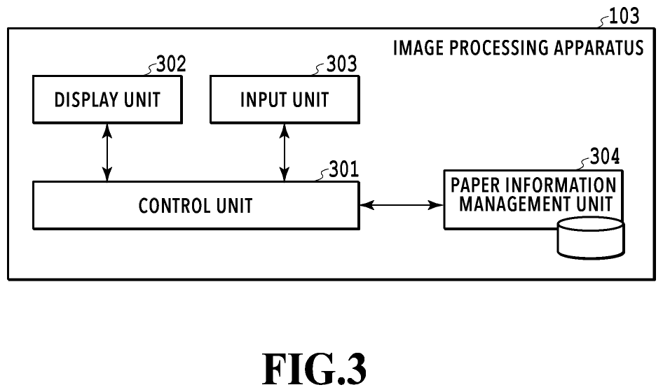

FIG. 3 is a diagram illustrating an example of a software configuration of the image processing apparatus 103. FIG. 3 illustrates an example of a processing function of a processing unit in the image processing apparatus 103 that is related to the present embodiment. The image processing apparatus 103 includes a control unit 301, a display unit 302, an input unit 303, and a paper information management unit 304. Each function unit illustrated in FIG. 3 is functioned by the CPU 201 as each unit illustrated in FIG. 3 with the CPU 201 reading and executing the program stored in the ROM 203 in the RAM 202.

The display unit 302 performs display control to display a state of the image processing apparatus 103 and to display an operation menu on the operation unit 212. The input unit 303 is an accepting unit (reception unit) that accepts (receives) an operation instruction from the user. The paper information management unit 304 processes the paper information and stores the paper information in a paper DB. The paper DB is implemented in the HDD 204 or the SRAM 209; however, the paper DB may be provided outside the image processing apparatus 103. The control unit 301 controls each unit illustrated in FIG. 3 and executes various types of processing.

### <Management of Paper Information>

Next, the paper information managed by the paper DB is described. As described above, the image processing apparatus 103 includes one or more feeding units and is formed to be able to set the paper information to each feeding unit. For example, in a case where the user performs printing by using the image processing apparatus 103, it is possible to execute higher quality printing by setting desired paper information to the feeding unit storing desired paper.

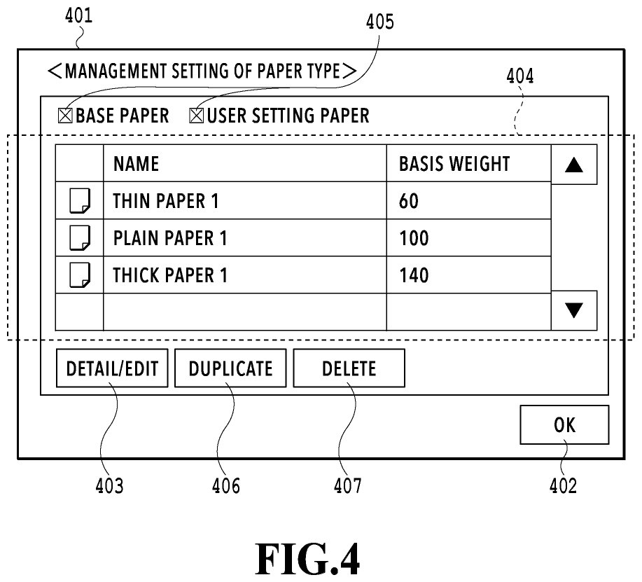

FIG. 4 is a diagram illustrating an example of a screen displayed on the operation unit 212 of the image processing apparatus 103. A screen 401 in FIG. 4 is a setting screen to perform management setting of the paper type (paper information). The screen 401 includes a paper information list 404. The paper information included in the paper information list 404 is the paper information already registered with the paper information management unit 304. In the example in FIG. 4, checkboxes 405 of both the base paper and user setting paper are checked; accordingly, both the paper information on the base paper type and paper information on the user setting paper type, which are described later, are included and displayed in the paper information list 404. In a case where the checkbox 405 of either one of the types is checked, the paper information on the checked type is included and displayed in the paper information list 404. On the screen 401 in FIG. 4, three types of paper information (paper types) named as “thin paper 1”, “plain paper 1”, and “thick paper 1” are displayed as a list.

The screen 401 includes regions of a detail/edit button 403, a duplicate button 406, a delete button 407, and an OK button 402. Once the user selects arbitrary paper information from the paper information list 404 and presses the detail/edit button 403, the duplicate button 406, or the delete button 407, processing according to the pressed button is performed. Note that, the pressing of the button also includes an operation to touch an icon as a UI component, for example. In a case where the detail/edit button 403 is pressed, processing of checking details of the selected paper and editing is allowed. Details are described later. In a case where the duplicate button 406 is pressed, the selected paper is duplicated. In a case where the delete button 407 is pressed, the selected paper is deleted. In a case where the OK button is pressed, the screen 401 illustrated in FIG. 4 is closed.

To be more specific, the input unit 303 detects the operation by the user and notifies the control unit 301 of which part (coordinates) on the screen is pressed. Based on a bitmap of the screen displayed on the operation unit 212 and the notified coordinates, the control unit 301 detects which button is pressed. The control unit 301 then performs the processing according to the button that the control unit 301 detects as being pressed, generates a screen that should be displayed subsequently, and notifies the display unit 302 of the contents. The display unit 302 displays the notified screen on the operation unit 212. Thus, the processing corresponding to the operation by the user is performed, and the screen transitions. In the present embodiment, processing in a case where the detail/edit button 403 is pressed is described.

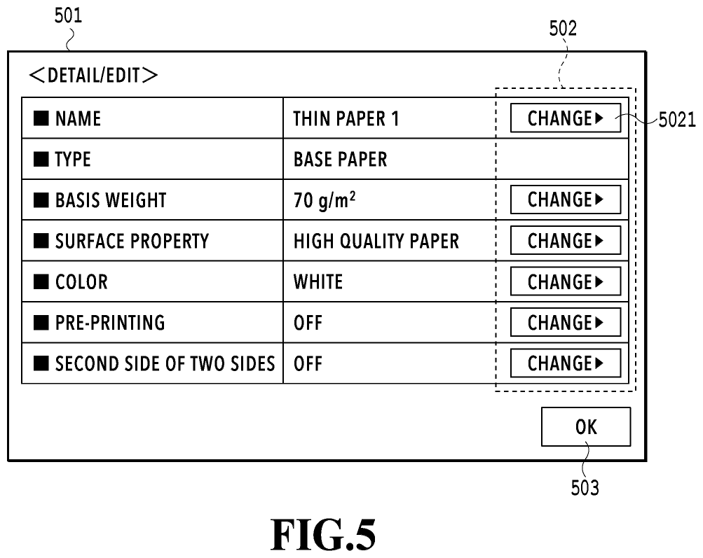

FIG. 5 is a diagram illustrating a screen 501 to check and edit the details of the paper information. Once the detail/edit button 403 is pressed in a state in which any one of the types of paper on the paper information list 404 is selected by the user on the screen 401 in FIG. 4, the displayed screen on the operation unit 212 is switched from the screen 401 to the screen 501. The screen 501 illustrates an example in which the “thin paper 1” on the paper information list 404 is selected.

The screen 501 shows details of the paper information on the “thin paper 1”. The paper information includes information (item) indicating the characteristics of the paper. Additionally, the paper information also includes information (item) indicating the attribute of the paper. Note that, although the characteristics and the attribute of the paper are separately described for the sake of convenience, all the items illustrated in FIG. 5 may be treated as the characteristics or the attribute of the paper. In the present embodiment, the name and the type are included as the item indicating the attribute of the paper. Items of basis weight, surface property, color, pre-printing, and second side of two sides are included as the item indicating the characteristics of the paper. A setting value is set to each item. In the example illustrated in FIG. 5, the setting value of the type item is “base paper”, and the setting value of the surface property is “high quality paper”.

The name indicates the name of the paper information (paper type) associated with the details being displayed such that the user can distinguish it from other paper information (paper type) with reference to the name. Additionally, the paper information management unit 304 manages the data by using the name as a key as well. That is, a configuration in which the same names are never applied for the data management by the paper information management unit 304 is applied. The type indicates whether it is the base paper or the user setting paper. The basis weight indicates a weight of the paper per unit area. In the present embodiment, g/m² (grams per square meter) is used; however, another unit may be applied. The surface property is an attribute that indicates the type of the paper. The color indicates a color of the paper. In the present embodiment, a name expressing a general color such as white, red, or blue is designated; however, as long as it is possible to distinguish the color from another color, a different color from DIC (a color chart issued by the DIC Corporation) and the like may be applied. The pre-printing indicates whether printing is already performed on the paper. The second side of two sides indicates whether it is paper dedicated for printing on the back side. Note that, the example of the item illustrated in FIG. 5 is merely an example, and it is not limited to this example.

In the screen 501 illustrated in FIG. 5, a change button group 502 is provided to so as to correspond to each item. Once the input unit 303 detects that any one of change buttons in the change button group 502 is pressed, a setting value change screen of the corresponding item is displayed to allow editing. Note that, in the present embodiment, since the change of the item of the type by the user is not allowed, no change button corresponding to the “type” is arranged. Alternatively, the change button corresponding to the “type” may be arranged, but it is arranged in an aspect of gray-out, for example, so as to prevent the pressing by the user.

Thus, in the present embodiment, a configuration in which the already-existing paper information is used such that a part of the paper information can be changed is applied. Additionally, in this case, the user can perform an editing operation to, for example, change the item as needed while checking the detailed information of the already-existing paper information. Therefore, for example, the user can perform the operation more intuitively than a case where the duplicate button 406 is pressed to duplicate the already-existing paper information once in the state of the screen 401 in FIG. 4. Moreover, since the user can perform the operation while checking the details of the paper information, it is also possible to reduce a load during the operation by the user. Note that, as described later, basically, the user registers the new paper information by changing a desired item and pressing an OK button 503. In other words, the OK button 503 can also be called a confirm button that indicates that the change (editing) of the paper information is confirmed.

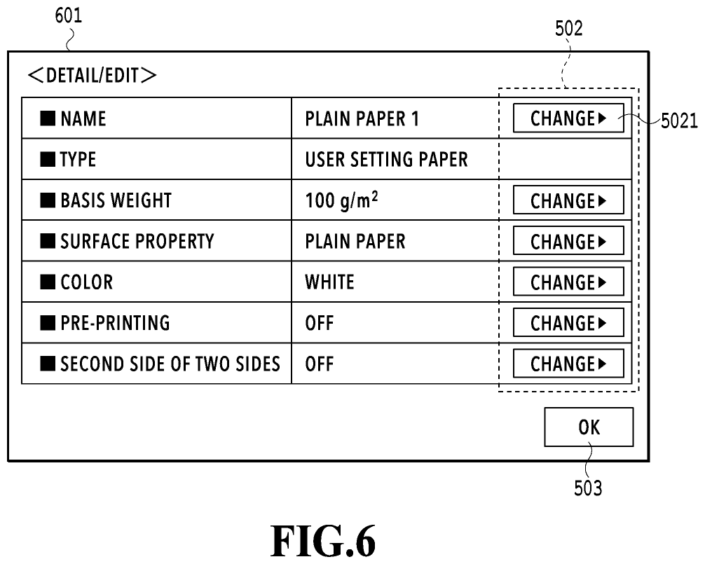

FIG. 6 is a diagram illustrating a screen to check and edit the details of the paper information. A screen 601 illustrated in FIG. 6 illustrates an example in which the “plain paper 1” on the paper information list 404 is selected. The configuration in the screen 601 is similar to the example described with reference to FIG. 5. The screen 501 illustrated in FIG. 5 is an example of a screen in a case where the type is the base paper, and the screen 601 illustrated in FIG. 6 is an example of a screen in a case where the type is the user setting paper.

As illustrated in FIGS. 5 and 6, in the present embodiment, a configuration in which the change button group 502 is arranged so as to allow for the change by the user not only in a case where the type is the user setting paper but also in a case of the base paper is applied. Note that, as described above, the base paper includes the characteristic value determined in advance, and the change of the characteristic value of the base paper itself is not allowed. Thus, in the present embodiment, the change button group 502 is arranged also for the base paper with the characteristic value that cannot be changed. Additionally, as described later, in a case where the OK button 503 (confirm button) is pressed in a state in which the setting value of the item of the base paper is changed, the control unit 301 performs processing of registering the new paper information indicating that the type is the user setting paper with the paper DB. In the descriptions below, the descriptions are given based on the screen in FIG. 5; however, the same applies to a case of the screen in FIG. 6.

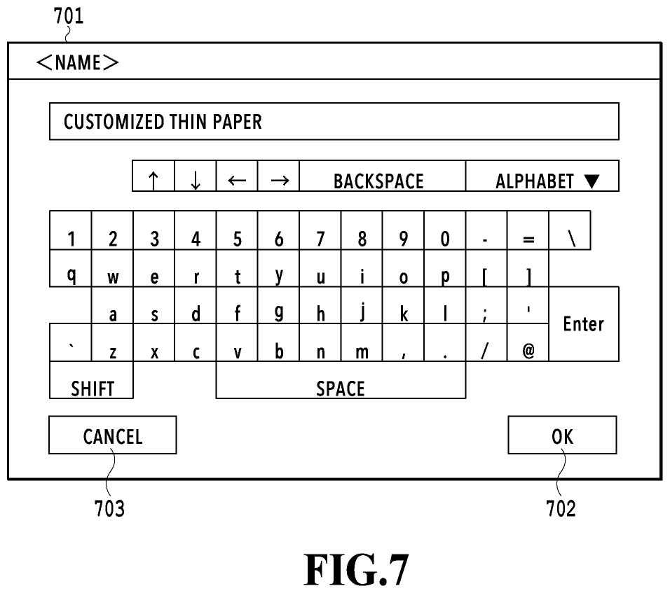

FIG. 7 is a diagram illustrating an example of a screen to change the name. Once it is detected that a change button 5021 corresponding to the item of the name is pressed on the screen 501 in FIG. 5, the control unit 301 performs control to display a screen 701 illustrated in FIG. 7. In other words, the screen on the operation unit 212 is switched from the screen 501 to the screen 701. The user can edit the name through the screen 701. The screen 701 is a screen that displays a keyboard, and the user can input the name through the displayed keyboard. Thus, the user can edit the name in any timing. Additionally, the user can distinguish the paper from other paper based on the name. Once an OK button 702 is pressed after the name is edited, the screen returns to the original screen 501 to which the edited name is reflected. Note that, the start of the processing of registration with the paper information management unit 304 (paper DB) is triggered by the pressing of the OK button 503 on the screen 501. Once a cancel button 703 is pressed on the screen 701, the contents being edited are discarded, and the screen returns to the original screen 501. The above is an example of a case where the name is changed. In a case where the setting value of characteristics other than the name is changed, a UI component to perform changing and a region to which a value can be directly inputted are displayed on the screen 501 as needed. Note that, a configuration in which the screen is switched to another screen to input the setting value on the screen may be applied also in a case where the setting value of characteristics other than the name is changed.

Once the input unit 303 detects that the OK button 503 is pressed on the screen 501, the control unit 301 determines whether the setting value is changed. Then, if no setting value is changed, the control unit 301 saves no setting value and returns to the screen in FIG. 4. If one or more setting values are changed, the control unit 301 determines whether the type of the paper information being edited is the base paper or the user setting paper.

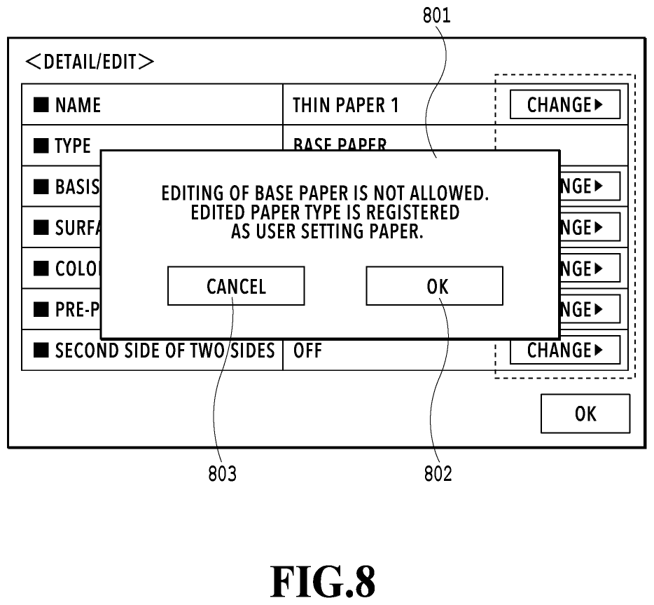

If it is determined as the base paper, the control unit 301 duplicates the base paper and registers the new paper information indicating that the type is the user setting paper with the paper information management unit 304. Then, after the registration, the control unit 301 determines whether the name of the registered paper information is already used. If the name is not already used, the control unit 301 saves the setting value in the paper information management unit 304 and returns to the screen in FIG. 4. The registered new paper information is displayed on the paper information list 404. If the name is already used, the operation screen is switched to a screen illustrated in FIG. 8.

FIG. 8 is an example illustrating a screen including a pop-up to select whether to register the changed setting value as the new paper information. In a case where the type is the base paper, and the name is already used, it means that the already used name is the name of the base paper. That is, there is a high possibility that the user is trying to change the setting value of the base paper itself. As described above, in the present embodiment, a configuration that does not allow for the change of the setting value of the base paper is applied. Therefore, a state in FIG. 8 is that a pop-up screen 801 notifying the user of that editing of the base paper is not allowed, and the edited type is registered as the user setting paper is displayed.

Once the input unit 303 detects that an OK button 802 is pressed on the pop-up screen 801, the screen is switched to the screen illustrated in FIG. 7. That is, since the name keeps being the same as the already used name of the base paper if this situation continues, the screen 701 is displayed to encourage the user to change the name. Then, once the input unit 303 detects that the OK button 702 is pressed on the screen 701, the control unit 301 changes the name of the setting value and saves the name in the paper information management unit 304, and the screen returns to the screen in FIG. 4. The registered new paper information is displayed on the paper information list 404.

Once the input unit 303 detects that a cancel button 803 is pressed on the pop-up screen 801, the control unit 301 saves no setting value and returns to the screen in FIG. 4. In this case, the paper information registered with the paper information management unit 304 is deleted. Thus, in the present embodiment, in a case where the OK button 503 (confirm button) is pressed in a case where the setting value is changed, the new paper information is registered with the paper information management unit 304 once. Then, in a case where the registration is canceled, the registered paper information is deleted.

The above is the descriptions of a case where the OK button 503 is pressed in a case where the type is the base paper. Next, a case where the OK button 503 is pressed in a case where the type is the user setting paper is described.

If it is determined that the type is the user setting paper, the control unit 301 saves the setting value in the paper information management unit 304. Then, the control unit 301 returns to the screen in FIG. 4. In a case where the type is the user setting paper, and the name is already used, processing of directly changing the already-existing paper information is performed. Therefore, the setting value of the paper information managed by the paper information management unit 304 is changed to the setting value set through the screen 601 in FIG. 6. Additionally, in a case where the name of the user setting paper is changed, since it is simply a case where the name of the paper information is changed, the setting value is also changed to the setting value (name) after the change.

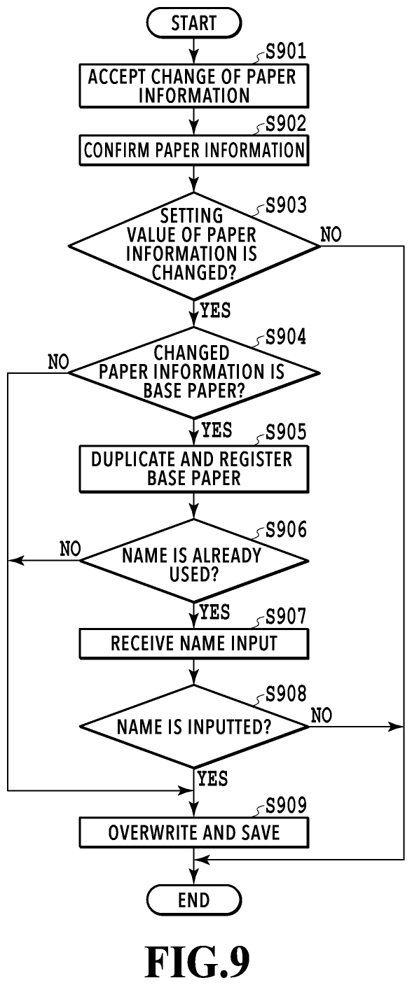

FIG. 9 is a flowchart illustrating an example of the processing of editing the paper information in the present embodiment. The flowchart illustrated in FIG. 9 is a flowchart illustrating processing in which, in a case where the paper information is edited, the duplication is performed and then new registration is performed if the type is the base paper, and overwriting and saving is performed if the type is the user setting paper. The processing illustrated in FIG. 9 is implemented with the CPU 201 reading the program stored in the ROM 203 to the RAM 202 and executing the program. In other words, as described above, the processing illustrated in FIG. 9 is implemented with the CPU 201 functioning as each unit illustrated in FIG. 3. Note that, a part of or all the functions of the steps in FIG. 9 may be implemented by hardware such as an ASIC or an electronic circuit. A sign “S” in each description of the processing means a step in the flowchart diagram. The processing in the flowchart illustrated in FIG. 9 is started in a case where the input unit 303 detects that the detail/edit button 403 is pressed in a state in which arbitrary paper information is selected from the paper information list 404 on the screen 401 in FIG. 4. The paper information selected from the paper information list 404 on the screen 401 is described below as the paper information on a processing target.

In S901, the input unit 303 accepts the change of the paper information on the processing target. Specifically, as described with reference to FIGS. 5 to 7, the user can change each setting value, and the input unit 303 accepts the change. Next, in S902, once the input unit 303 detects that the OK button 503 is pressed, the control unit 301 confirms the paper information on the processing target. In other words, the control unit 301 determines that the editing of the paper information on the processing target is completed. Note that, S901 is arbitrary processing performed by the user operation, and the paper information on the processing target may be confirmed in S902 with no change of the paper information on the processing target.

Next, in S903, the control unit 301 determines whether the setting value of the paper information on the processing target is changed. The control unit 301 determines whether the setting value of the paper information on the processing target is changed with reference to the setting value saved in the paper DB of the paper information management unit 304. If it is determined that the setting value of the paper information is changed, the control unit 301 allows the process to proceed to S904. If it is determined that the setting value of the paper information is not changed, the control unit 301 ends the processing in the flowchart illustrated in FIG. 9.

In S904, the control unit 301 determines whether the paper information on the processing target in which the setting value is changed is the base paper. In other words, the control unit 301 determines whether the type of the paper information on the processing target is the base paper or the user setting paper. If it is determined that the changed paper information is the base paper, the control unit 301 allows the process to proceed to S905. If it is determined that the changed paper information is not the base paper, in other words, if it is determined that the changed paper information is the user setting paper, the control unit 301 allows the process to proceed to S909.

In S905, the control unit 301 duplicates the paper information of the changed setting value (base paper) and registers the duplicated paper information as the new paper information indicating that the type is the user setting paper with the paper information management unit 304. As described above, a configuration that does not allow for the change of the setting value of the base paper is applied. Therefore, the processing of duplicating the paper information in which the setting value is changed first and registering the type as the user setting paper with the paper information management unit 304 is performed. Next, in S906, the control unit 301 determines whether the name of the duplicated and registered new paper information is already used. If it is determined that the name is already used, the control unit 301 allows the process to proceed to S907. If it is determined that the name is not already used, the control unit 301 allows the process to proceed to S909.

A case where it is determined in S906 that the name is already used is a case where the OK button 503 is pressed without changing the name even though the item other than the name is changed in editing the paper information in which the type is the base paper by the user. In this case, registration of the paper information without changing the name is not allowed; for this reason, in S907, the control unit 301 receives an input of the name. Specifically, the pop-up screen 801 illustrated in FIG. 8 is displayed, and thereafter, in a case where it is detected that the OK button 802 is pressed, the screen 701 illustrated in FIG. 7 is displayed. Then, the screen 701 receives the input of the name. Note that, although an example in which the screen 701 illustrated in FIG. 7 is displayed after the pop-up screen 801 in FIG. 8 is displayed is described herein, a configuration in which the screen 701 in FIG. 7 is displayed without displaying the pop-up screen 801 in FIG. 8 may be applied.

Next, in S908, the control unit 301 determines whether the name is inputted. For example, it is determined whether a different name is inputted, and the OK button 702 is pressed on the screen 701 illustrated in FIG. 7. If it is determined that the name is inputted, the control unit 301 allows the process to proceed to S909. If it is determined that no name is inputted, the control unit 301 ends the processing in the flowchart illustrated in FIG. 9. Note that, if it is determined that no name is inputted, for example, there may be included a case where the cancel button 803 is pressed on the pop-up screen 801 in FIG. 8, a case where the cancel button 703 is pressed on the screen 701 in FIG. 7, and the like. Note that, although it is not illustrated in the flowchart in FIG. 9, in a case where the same name as that of other paper information is inputted as a result of pressing of the OK button 702 on the screen 701, the processing in S907 is performed again. That is, in a case where a name different from the name of the base paper is inputted, but it is the same name as that of other paper information, the processing in S907 is performed again.

In S909, the control unit 301 overwrites and saves the paper information on the processing target registered with the paper information management unit 304 using the changed setting value. Then, the control unit 301 ends the processing in the flowchart illustrated in FIG. 9.

A case where it is determined as No in S904, and the process proceeds to S909 is a case where the setting value of the paper information in which the type is the user setting paper is changed. In this case, in S909, processing of overwriting and saving the setting value of the paper information on the processing target registered with the paper information management unit 304 using the changed setting value is performed.

A case where it is determined as No in S906, and the process proceeds to S909 is a case where the setting value of the paper information in which the type is the base paper is changed, and the name is also changed. Note that, a case where only the name is changed is also included in this case. In this case, it is a state in which the paper information in which the type is already the user setting paper in S905 is newly registered with the paper information management unit 304. Processing of overwriting and saving the setting value of the registered paper information using the changed setting value is performed.

A case where it is determined as Yes in S908, and the process proceeds to S909 is a case where the setting value of the paper information in which the type is the base paper is changed, and after a state in which the name is not changed from that of the base paper, the name is changed to a different name. In this case, with the changed setting value also including the thus-changed name, the processing of overwriting and saving the setting value of the paper information newly registered with the paper information management unit 304 in S905 is performed.

As described above, according to the present embodiment, it is possible to improve the usability in changing the paper information. In other words, in the present embodiment, a configuration in which the new paper information can be registered with the user changing the setting value while checking the details of the base paper without performing the user operation to duplicate the base paper in registering the new paper information. That is, in the point of view of the user, it is possible to newly register the paper information that has a desired setting value without being particularly aware of that it is the base paper. On the other hand, in the image processing apparatus 103, the positioning of the base paper that the change of the setting value is not allowed is still maintained, and in a case where the type in which the setting value is changed is the base paper, the type is internally changed to the user setting paper, and the registration processing is performed. Thus, it is possible to improve the usability in changing the paper information while maintaining the positioning of the base paper.

### OTHER EMBODIMENTS

In the above-described embodiments, an example in which the paper information is edited and registered by using the operation unit 212 of the image processing apparatus 103 is described; however, it is not limited to this example. The processing of editing and registering the paper information used by the image processing apparatus 103 may be performed on an operation screen of the server apparatus 101 or the client apparatus 102.

Additionally, in the above-described embodiments, an example in which the base paper is duplicated and registered once even in a case where the name is already used is described; however, it is not limited to this example. Whether the name is already used may be determined before the base paper is duplicated and registered, and after the duplicated use of the name is resolved, the base paper may be duplicated and registered with the name after the resolution.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-066520, filed Apr. 14, 2023, which is hereby incorporated by reference wherein in its entirety.

What is claimed is:

1. An information processing apparatus comprising:
one or more memories storing instructions; and
one or more processors executing the instructions to:
accept an editing operation to change registered first paper information; and
register paper information based on the accepted editing operation as second paper information, which is different from the first paper information, in a case where a type of the first paper information is base paper, and overwrite the registered first paper information with the paper information based on the editing operation in a case where the type of the first paper information is not the base paper.

2. The information processing apparatus according to claim 1, wherein
in a case where the type of the first paper information is the base paper, if a name of the paper information based on the editing operation is already used as that of registered paper information, change of the name is accepted.

3. The information processing apparatus according to claim 2, wherein
in a case where the name is changed, the registered second paper information is overwritten with a changed name.

4. The information processing apparatus according to claim 2, wherein
in a case where the name is not changed, the registered second paper information is deleted.

5. The information processing apparatus according to claim 1, wherein
a setting value of paper information on the type that is the base paper is managed as unchangeable value.

6. The information processing apparatus according to claim 1, wherein
the paper information includes a setting value indicating characteristics of paper.

7. The information processing apparatus according to claim 1, wherein
registered paper information can be set in a case where printing is performed.

8. The information processing apparatus according to claim 1, wherein
the first paper information is registered with a management unit, and the second paper information is registered with the management unit.

9. An information processing apparatus comprising:
one or more memories storing instructions; and
one or more processors executing the instructions to:
accept a user operation; and
perform control that allows a display unit to display
a first screen including a list of registered paper information and
a second screen configured to be displayed after selection of paper information in which a type is base paper is received by the first screen, wherein
the second screen includes a region to accept change of the selected paper information.

10. The information processing apparatus according to claim 9, wherein
a setting value of paper information on the type that is the base paper is managed as unchangeable value.

11. A method of controlling an information processing apparatus comprising:
accepting an editing operation to change registered first paper information; and
registering paper information based on the accepted editing operation as second paper information, which is different from the first paper information, in a case where a type of the first paper information is base paper.
